(19) United States
(12) Patent Application Publication
(10) Pub. No.: US 2017/0142029 A1
(43) Pub. Date: May 18, 2017

(54) METHOD FOR DATA RATE ADAPTION IN ONLINE MEDIA SERVICES, ELECTRONIC DEVICE, AND NON-TRANSITORY COMPUTER-READABLE STORAGE MEDIUM

(71) Applicants: LE HOLDINGS (BEIJING) CO., LTD., Beijing (CN); LECLOUD COMPUTING CO., LTD., Beijing (CN)

(72) Inventor: Yangang Xia, Beijing (CN)

(21) Appl. No.: 15/248,703

(22) Filed: Aug. 26, 2016

Related U.S. Application Data
(63) Continuation of application No. PCT/CN2016/083016, filed on May 23, 2016.

(30) Foreign Application Priority Data
Nov. 16, 2015 (CN) 201510784238.2

(51) Int. Cl. H04L 12/911; H04L 12/927; H04L 29/06

(52) U.S. Cl. CPC H04L 47/821; H04L 65/607; H04L 47/80

(57) ABSTRACT

Disclosed are a method and electronic device for data rate adaption in online media services, the method including: collecting and analyzing network bandwidth information of users to obtain bandwidth utilization; determining a corresponding optimal data rate according to the bandwidth utilization; comparing the optimal data rate with a data rate of a current streaming media transmission, and deciding whether to adjust the data rate of the current streaming media transmission; maintaining the data rate of the current streaming media transmission and transmitting stream media data to users if adjustment is not necessary; or transmitting stream media data to users based on the optimal data rate if adjustment is necessary. The stream media business systems can adapt to time-varying characteristics of the channel to achieve coherence and stability of the stream media data transmission to improve application service quality to a certain extent.

### CROSS REFERENCE TO RELATED APPLICATIONS

This application is a continuation of International Application No. PCT/CN2016/083016, filed on May 23, 2016, which is based upon and claims priority to Chinese Patent Application No. 201510784238.2, filed on Nov. 16, 2015, the entire contents of each of which are incorporated herein by reference.

### TECHNICAL FIELD

The disclosure relates to the field of Internet information transmission and, in particular, to a method and system for data rate adaption in online media services.

### BACKGROUND

Data Rate refers to the data flow used by a video file in a unit of time, also called code rate or flow rate, and usually indicated in kb/s or Mb/s, which is an important part of picture quality control in video encoding. Generally, under the same resolution, the larger data rate of a video file, the smaller the compression ratio and the higher the picture quality. The larger the data rate, the larger the sampling rate, the higher the accuracy of the data flow, and the document after being processed is closer to the original, hence the picture instruction is better and the picture is clearer.

With the popularization and development of wireless network access, many electronic products are equipped with wireless networking capabilities. In particular, new mobile real-time video surveillance equipment need to have the ability to access a wireless network to achieve the desired remote monitoring and control functions. However, it is well-known that the general flow of the video data rate data is relatively large. For example, video enthusiasts should appreciate that the thrilling and drastic scenes normally change rapidly with large data flow, and are difficult to compress, thus requiring a very high data rate to accurately present and display. Regarding compression parameters, only by sampling data at a stream rate of at least 10 Mb can the originality of a variety of high-definition picture qualities be ensured without any loss of details within static images and intense scenes, to obtain a pure HD quality after the compression. This provides a solid foundation at the program source end for rendering consumers a high-definition experience.

While on the Internet, due to the “try the best” feature of TCP/IP network, transmission of multimedia data streams will have the issues of packet loss and have a much higher error rate due to the poor environment of transmission channels utilized in mobile communications and the poor channel quality and inadequate flow control mechanisms. The compressed video stream is very sensitive to errors, and even if the received packet's error rate is very low, it can cause a large impact on the quality of the decoded image. In addition, problems regarding excessive amounts of data and unstable network quality of service may also lead to a slower transfer rate or even a transfer failure.

Conventionally, due to multipath fading of channels, transmission block, mobile switching, delay, etc., the bandwidth fluctuation of a transmission channel is typically large, and the error rate as well as blocking loss are serious. In addition to the compressed and encoded video data, it is very sensitive to channel errors, and causes severe decline in quality of image rehabilitated under the errors environmental. Thus, streaming media service system needs to adapt to time-varying characteristics of the channel to achieve coherence and stability of stream media data transmission. Therefore, the current status of network cannot be reflected instantly, which results in the status of network being indicated slowly and the size of the encoding data rate may not be adjusted in time, thereby bringing about a negative visual sense for users.

### SUMMARY

In order to solve the aforementioned problems, i.e., that the current status of network cannot be indicated instantly and that the size of the code data rate cannot be adjusted in time, an embodiment of the disclosure includes a method for data rate adaption in online media services, including:

collecting and analyzing network bandwidth information of users to obtain bandwidth utilization;

determining a corresponding optimal data rate according to the bandwidth utilization;

comparing the optimal data rate with a data rate of a current stream media transmission, and deciding whether to adjust the data rate of the current stream media transmission;

maintaining the data rate of the current stream media transmission and transmitting stream media data to users if adjusting is not necessary; and

transmitting stream media data to users based on the optimal data rate if adjusting is necessary.

Another embodiment of the disclosure includes an electronic device, which may include: at least one processor; and a memory communicably connected with the at least one processor configured to store instructions executable by the at least one processor, wherein execution of the instructions by the at least one processor causes the at least one processor to execute the method for data rate adaption in online media services mentioned above.

In yet another embodiment of the disclosure, a non-transitory computer-readable storage medium is provided for storing executable instructions that, when executed by an electronic device, cause one or more processors associated with the electronic device to execute the method for data rate adaption in online media services mentioned above.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for data rate adaption in online media services according to an embodiment of the disclosure;

FIG. 2 shows a detailed implementation of one specific embodiment of step 3 of the method shown in FIG. 1;

FIG. 3 is a detailed implementation of another specific embodiment of step 2 of the method shown in FIG. 1;

FIG. 4 is a schematic diagram of a system for data rate adaption in online media services according to an embodiment of the disclosure;

FIG. 5 is an architecture diagram for implementing a method and system for data rate adaption in online media services according to an embodiment of the disclosure; and

FIG. 6 is an architecture diagram of an electronic device or a server for implementing a method for data rate adaption in online media services according to an embodiment of the disclosure.

### DETAILED DESCRIPTION

In order to make the purpose, technical solutions, and advantages of the embodiments of the invention more clearly, technical solutions of the embodiments of the disclosure will be described clearly and completely in conjunction with the figures.

Obviously, the described embodiments are merely part of the embodiments of the disclosure, but do not include all possible embodiments. Based on the embodiments of the disclosure, other embodiments obtained by the ordinary skill in the art without undue experimentation are within the scope of the disclosure.

It should be noted that, embodiments of the present application and the technical features involved therein may be combined with each other in case they are not conflict with each other.

According to OSI (Open System Interconnect), network communication is divided into seven layers, namely a physical layer, a data link layer, a network layer, a transport layer, a session layer, a presentation layer and an application layer. The disclosure provides a method for data rate adaption that utilizes the application layer to control the transmission of multimedia data at the source, so as to solve problems of network congestion in transmission.

The disclosure can be used to play any suitable number and/or type of existing documented sources, for example, playing back movies and TV shows.

In order to enhance the adaptability of audio and video dispatching system to network conditions, a scalability design may be performed for streaming media data transmission. The dynamic changes of network status may be fed back to a video dispatch system via any suitable number and/or type of techniques. For example, according to a control strategy, a video dispatch system can be better matched with the dynamic changes in the network, which improves quality of an application service to a certain extent.

In the streaming media data transmission process described herein, by collecting and analyzing information on network bandwidth through which streaming media data transmits, a scalability design may be performed for streaming media data transmission and combined with dynamic code to match the dynamic changes in the network to obtain the desired output data rate. For example, different media data may be encoded according to different network bandwidth utilization, and/or encoded data rate may be output matched to a network with different speed, thereby improving the application services quality of data transmission under Internet environments.

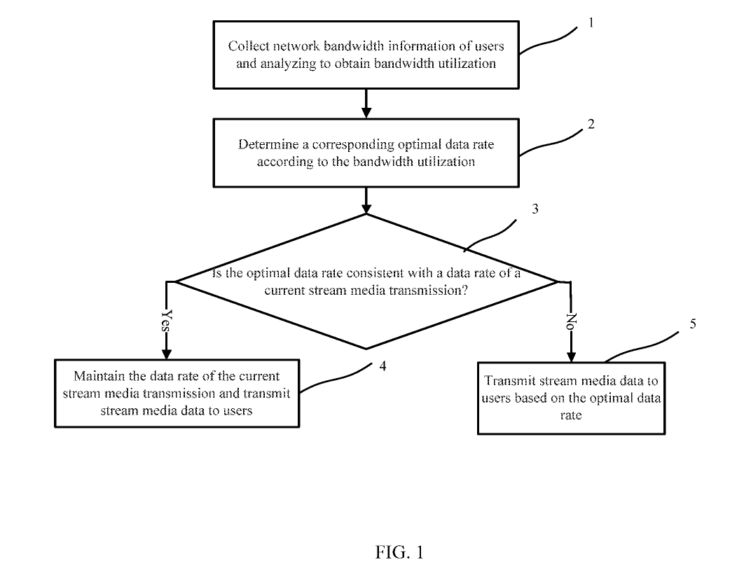

FIG. 1 is a flow chart showing a filtering and analyzing method according to an embodiment of the present application. Referring to FIG. 1, which illustrates a method for data rate adaption in online media services according to an embodiment of the disclosure, the method includes:

Step 1: collecting network bandwidth information of users for the video dispatching center to analyze bandwidth utilization;

Step 2: determining, at the video dispatching center, a corresponding optimal data rate according to the bandwidth utilization;

Step 3: comparing, at the video dispatching center, the optimal data rate with a data rate of a current stream media transmission, and deciding whether adjusting the data rate of the current stream media transmission;

Step 4: maintaining the data rate of the current stream media transmission and transmitting stream media data to users if adjustment is not necessary; and

Step 5: transmitting stream media data to users based on the optimal data rate if adjustment is necessary.

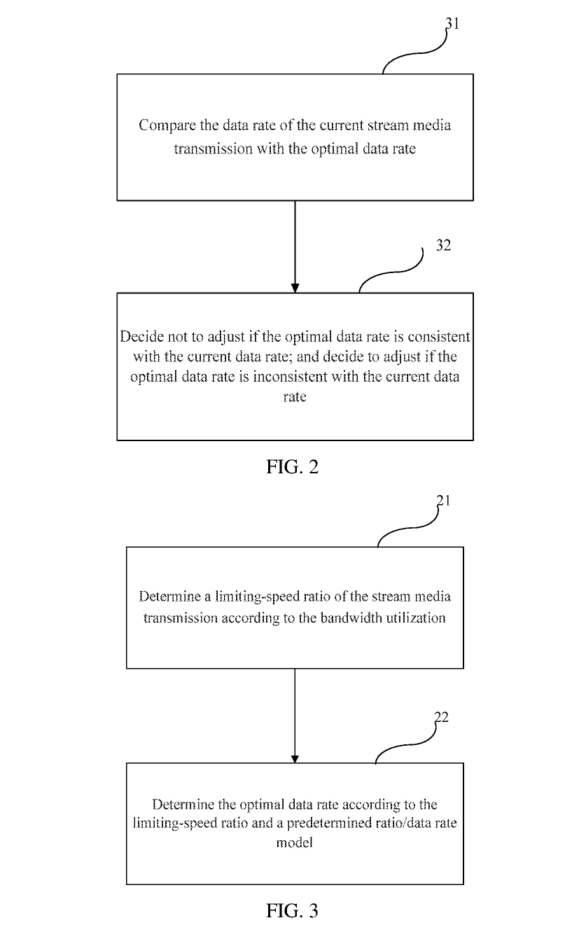

FIG. 2 shows a detailed implementation of one specific embodiment of step 3 of the method shown in FIG. 1. The above Step 3, for example, can be implemented by the following sub-steps, including:

Step 31: comparing, at the video dispatching center, the data rate of the current stream media transmission with the optimal data rate; and

Step 32: deciding, by the video dispatching center, not to adjust if the optimal data rate is consistent with the current data rate, or to adjust if the optimal data rate is inconsistent with the current data rate.

FIG. 3 is a detailed implementation of another specific embodiment of step 2 of the method shown in FIG. 1. In an embodiment, the above-described step 2, for example, can be implemented by the following sub-steps.

Step 21: The video dispatching center determines a rate-limiting ratio of the stream media transmission according to the bandwidth utilization.

Step 22: The video dispatching center determines the optimal data rate according to the rate-limiting ratio and a predetermined ratio/data rate model.

In an embodiment, the above predetermined ratio/data rate model may include, for example, an interval model. For example, it may be a table determined based on a ratio of download speed of a user in the historical data and the data rate and based on performance quality of stream media playing, and the table is stored into a database. When the form is used, it can be invoked and compared with the rate-limiting ratio to determine the optimal data rate. At the same time, the predetermined ratio/data rate model can also be updated periodically or on demand to improve the accuracy of the model.

The above Step 1 of collecting and analyzing network bandwidth information of users to obtain bandwidth utilization includes the following steps.

The video dispatching center determines bandwidth utilization according to a predetermined download speed corresponding to the collected network bandwidth information of a user and a current download speed of the user.

Bandwidth information is collected by a number of agent programs deployed on the nodes, and reported to the dispatcher after collecting to summarize and analyze the information to obtain the network bandwidth utilization.

Network bandwidth utilization is inversely proportional to network service quality. The lower the utilization, the better the network service quality, and vice versa. In general, high network bandwidth utilization is the main cause for packet loss, congestion, and delay.

The above rate-limiting ratio is calculated by using the formula y=kx+b, which is based on network bandwidth utilization. In the aforementioned formula, y represents the rate-limiting ratio of stream media transmission, x represents bandwidth utilization, k represents the scaling coefficient, and is negative, and b represents proportional adjustment cardinality, and is positive. Values of k and b are determined, for example, based on historical experience.

For example, there is a phenomenon that people often “chase” good television programs. However, some programs are played in the evening between 10:00 pm to 12:00 pm. Because of prior commitments (e.g., work), people may need to give up watching the programs as they initially air, and then watch the program as it is replayed the next day. However, because many people may be watching the video as it is replayed the next day, the large number of users may result in a high utilization of network bandwidth, causing network congestion, which may block and halt program playback. The network congestion problem can be solved, for example, by adjusting the appropriate data rate and comparing the rate-limiting ratio/data rate model calculated by the aforementioned formula to the determined optimal data rate transmitting the steam media data to users.

Further improvements of the above method for data rate adaption in online media services include, for example, if the current data rate is already in the highest data rate, there is no need to adjust, and the video dispatching center also transmits the stream media with the current data rate.

Further modification of the above embodiment is that, if the current data rate is at the lowest level (e.g., below some threshold), the video dispatching center performs a dropping-frame filtering operation. Specifically, in accordance with the different functions of B frame, P-frame, and I-frame in the stream media encoding frame structure, when the network is congested, the streaming server may choose to first drop sending the B-frame data. If there is still a congestion, the P-frame may be discarded, with only the I-frame data being sent. Then, if network condition is still not good, a jumping I-frame may be adopted. That is, one or more of the I-frame data is discarded for successive I-frames, so as to solve the bad network status problem, mitigate slow network congestion, and ensure the real-time of stream media data transmission. When network conditions recover gradually, the video dispatching center may be gradually restored to send the I-frame, P-frame, and B-frame data.

Through collecting network bandwidth information as described herein, the video dispatching center (which may be implemented, for example, as a server or server cluster) can make the service streaming media service system adapt to time-varying characteristics of the channel. This may solve the problem regarding the severe decline in quality of image rehabilitated under the error code environment by automatically encoding and adjusting the data rate based on the collected bandwidth information, and controlling the transmission rate of stream media. This ensures the coherence and stability of stream media data transmission in the internet environment, so as to adapt to different network conditions and improve the users' experience.

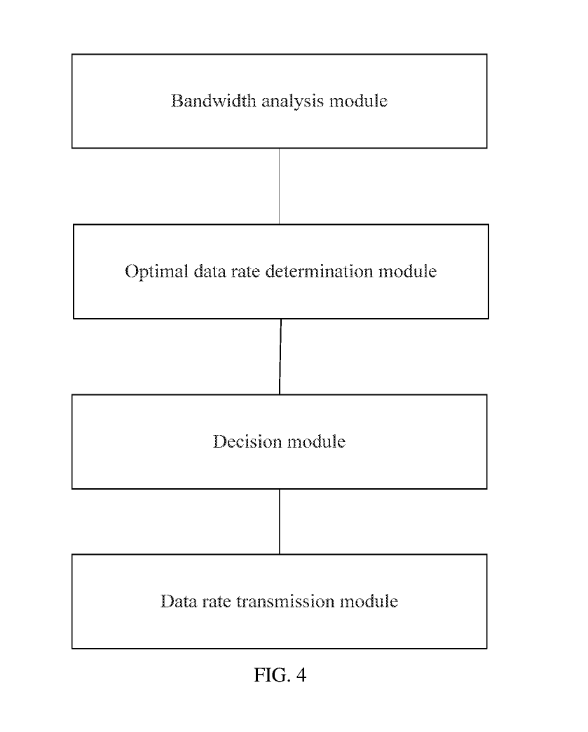

FIG. 4 is a schematic diagram of a system for data rate adaption in online media services according to an embodiment of the disclosure. Referring to FIG. 4, which also shows a system for data rate adaption in online media services. In an embodiment, the system includes:

a bandwidth analysis module configured to collect and analyze network bandwidth information of users to obtain bandwidth utilization;

an optimal data rate determination module configured to determine a corresponding optimal data rate according to the bandwidth utilization;

a decision module configured to compare the optimal data rate with a data rate of a current stream media transmission, and to decide whether to adjust the data rate of the current stream media transmission; and

a data rate transmission module configured to maintain the data rate of the current stream media transmission or transmit stream media data to users based on the optimal data rate.

The video dispatching center in the system for data rate adaption in online media services in the present embodiment is a server or server cluster, wherein each module can be a standalone server or server cluster. Under the circumstances, interactions among the modules are actually interactions among the servers or server clusters corresponding to each module. In this case, the multiple servers or server clusters constitute the system for data rate adaption in online media services of the disclosure.

Specifically, when the system for data rate adaption in online media services of the disclosure are implemented as multiple servers or server clusters, the implementation may include:

a bandwidth analysis server or server cluster configured to collect and analyze network bandwidth information of users to obtain bandwidth utilization;

an optimal data rate determination server or server cluster configured to determine a corresponding optimal data rate according to the bandwidth utilization;

a decision server or server cluster configured to compare the optimal data rate with a data rate of a current stream media transmission, and decide whether to adjust the data rate of the current stream media transmission;

a data rate transmission server or server cluster configured to maintain the data rate of the current stream media transmission or transmit stream media data to users or transmitting stream media data to users based on the optimal data rate.

In an alternative embodiment, several modules in the plurality of modules may be integrated and/or otherwise constitute a server or server cluster. For example, the bandwidth analysis module and the optimal data rate determination module together form the first server or the first server cluster, the decision module forms a second server or a second server cluster, and the data rate transmission module forms a third server or a third server cluster.

In this case, interactions among the modules are actually interactions among the first server to a third server or the interactions among the first server cluster to the third server cluster. The first server to the third server or the first server cluster to the third server cluster may constitute a system for data rate adaption in online media services of the disclosure.

The decision module is configured to compare the optimal data rate with a data rate of a current stream media transmission, and to decide not to perform the adjustment if the optimal data rate is consistent with the current data rate; and decide to perform the adjustment if the optimal data rate is inconsistent with the current data rate.

The optimal data rate code determination module is configured to determine a rate-limiting ratio of the stream media transmission according to the bandwidth utilization; and determine the optimal data rate according to the rate-limiting ratio and a predetermined ratio/data rate model.

The predetermined ratio/data rate model is determined based on a ratio between download speed of the user in the historical data and the data rate and also based on performance quality of stream media playing.

The bandwidth analysis module is configured to determine bandwidth utilization according to a predetermined download speed corresponding to collected network bandwidth information of a user and current download speed of the user.

The disclosure transmits the played back stream media data through the bandwidth analysis module, the decision module, and the data rate transmission module, and utilizes the collected network bandwidth information of users to analyze bandwidth utilization. Thus, the rate-limiting ratio of stream media transmission may be calculated. According to the transmission time information, it is determined whether the current mobile Internet network is congested. If so, the level of data rate is reduced, and otherwise the level of the data rate is maintained or increased to achieve the dynamic adjustment for the mobile stream media communication data rate according to the changes of the mobile Internet bandwidth information. The size of the code stream of the streamed media traffic and the transmission rate is thereby automatically adjusted to ensure the stability of the real-time transmission of the streaming media audio and video data under the mobile Internet environment and to enhance the user experience.

The above method and system for data rate adaption in an online media service may include adapting the streaming media service system to time-varying characteristics of channels and relieving the severe decline of image quality caused by environmental errors by automatically encoding and adjusting the data rate based on the collected bandwidth information and controlling the transmission rate of stream media. In this way, the coherence and stability of stream media data transmission are ensured in the internet environment, different network conditions are adapted to, and the users' experience is improved.

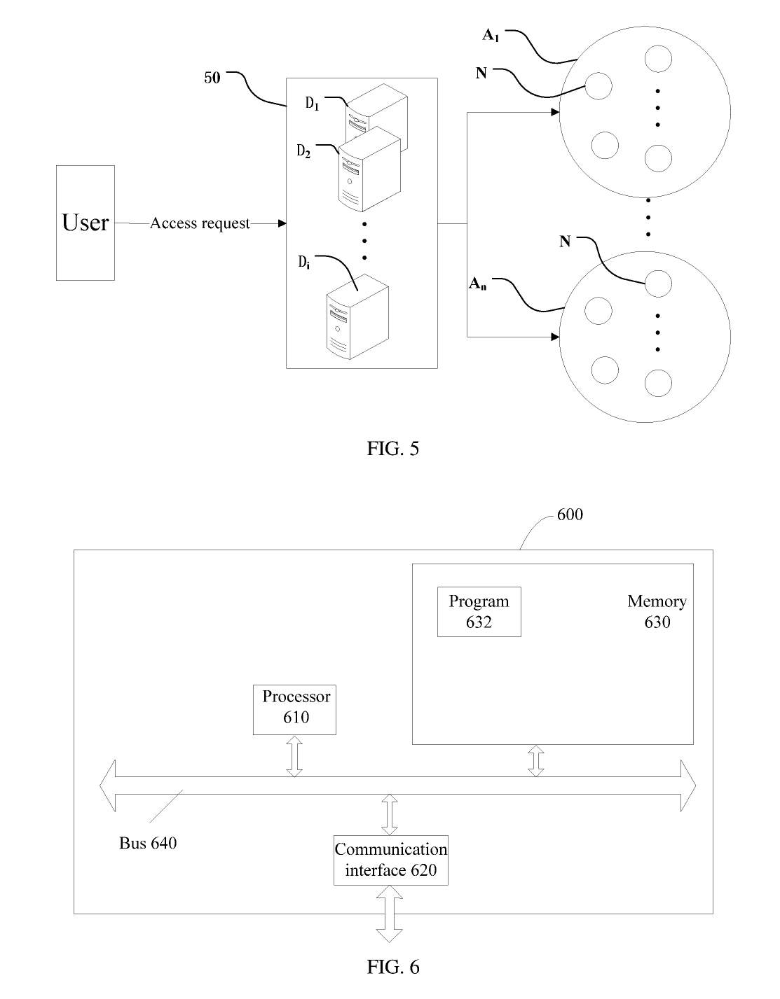

FIG. 5 is an architecture diagram showing the implementation of a method and system for data rate adaption in online media services according to an embodiment of the disclosure, which includes a video dispatching center 50, and any suitable number n of areas A1-An. The dispatching center 50 includes a plurality of servers, which may include any suitable number i of servers D1-Di. Each of areas A1-An respectively includes a plurality of edge CDN nodes N configured to provide streaming media services to users. After the server in the video dispatch center of the architecture diagram receives the video access request sent by a user through a client terminal (e.g., an intelligent terminal), the server implements the method for date rate adaption as shown in FIG. 1 of the disclosure to automatically adjust the size of the code stream (or data rate) of the stream media traffic and the transmission ratio for the users.

An embodiment of the present application provides a non-transitory computer-readable storage medium storing executable instructions that, when executed by one or more processors associated with an electronic device, cause the electronic device to execute the method for data rate adaption in online media services mentioned above.

FIG. 6 is an architecture diagram of an electronic device or a server for implementing a method for data rate adaption in online media services according to an embodiment of the disclosure. FIG. 6 shows a structural schematic of an electronic device or the network dispatching server 600 of an embodiment of the disclosure, although the embodiments of the present application is not limited the specific implementation of the server 600. As shown in FIG. 6, the electronic device or the server 600 may include a processor 610, a communication interface 620, a memory 630, and a communication bus 640.

The processor 610, the communication interface 620, and memory 630 may communicate with each other via the communication bus 640 in accordance with any suitable number and/or type of communication protocols.

The communication interface 620 communicates with the network elements such as client terminals.

Processor 610 executes program 632, and specifically, to execute the related steps in the above method embodiment.

Specifically, program 632 may include program code, and the program code includes computer operation instructions.

In various embodiments, processor 610 may be any suitable type of computer processor, such as, for example, a central processing unit CPU, an Application Specific Integrated Circuit ASIC, etc., or may be configured as part of one or more integrated circuits for implementing the present embodiment of the application.

The server in the above-described embodiment includes:

a memory configured to store computer operation instructions;

a processor configured to execute the computer operation instructions stored in the memory, to perform the following functions:

collect and analyze network bandwidth information of users to obtain bandwidth utilization;

determine a corresponding optimal data rate according to the bandwidth utilization;

compare the optimal data rate with a data rate of a current stream media transmission, and decide whether to adjust the data rate of the current stream media transmission;

maintain the data rate of the current stream media transmission and transmit stream media data to users if adjustment is not necessary; and

transmit stream media data to users based on the optimal data rate if adjustment is necessary.

The foregoing embodiments are illustrative, in which those units described as separate parts may or may not be separated physically. Illustrated components may or may not be physical units, i.e., may be located in one place or distributed in several locations among a network. Some or all modules may be selected according to practical requirement to realize the purpose of the embodiments, and such embodiments can be understood and implemented by the skilled person in the art without undue experimentation.

A person skilled in the art can clearly understand from the above description of embodiments that these embodiments can be implemented through software in conjunction with general-purpose hardware, or directly via hardware implementations. Based on such understanding, the essence of foregoing technical solutions, or those features making contribution to the prior art may be embodied as software product stored in computer-readable medium such as ROM/RAM, diskette, optical disc, etc., and including instructions for execution by a computer device (such as a personal computer, a server, or a network device) to implement methods described by foregoing embodiments or a part thereof.

Finally, it should be noted that, the above embodiments are provided to describe the technical solutions of the disclosure, but are not intended as a limitation. Although the disclosure has been described in detail with reference to the embodiments, those skilled in the art will appreciate that the technical solutions described in the foregoing various embodiments can still be modified, or some technical features therein can be equivalently replaced. Such modifications or replacements do not make the essence of corresponding technical solutions depart from the spirit and scope of technical solutions embodiments of the disclosure.

What is claimed is:

1. A method for data rate adaption in online media services in an electronic device, comprising:
collecting and analyzing network bandwidth information of users to obtain bandwidth utilization;
determining a corresponding optimal data rate according to the bandwidth utilization;
comparing the optimal data rate to a data rate of a current streaming media transmission, and deciding whether to adjust the data rate of the current streaming media transmission based upon the comparison;
maintaining the data rate of the current streaming media transmission and transmitting stream media data to users if adjustment is not necessary; and
transmitting stream media data to users based on the optimal data rate if adjustment is necessary.

2. The method of claim 1, wherein the act of comparing the optimal data rate to the data rate of the current streaming media transmission, and deciding whether to adjust the data rate of the current streaming media transmission comprises:
comparing the data rate of the current streaming media transmission to the optimal data rate,
deciding to not adjust the data rate of if the optimal data rate is consistent with the current data rate; and
deciding to adjust the data rate if the optimal data rate is inconsistent with the current data rate.

3. The method of claim 1, wherein the act of determining a corresponding optimal data rate according to the bandwidth utilization comprises:
determining a rate-limiting ratio of the streaming media transmission according to the bandwidth utilization; and
determining the optimal data rate according to the rate-limiting ratio and a predetermined ratio/data rate model.

4. The method of claim 3, wherein the predetermined ratio/data rate model is determined based on a (i) ratio between download speed of the user in the historical data and the data rate, and (ii) performance quality of streaming media that is playing.

5. The method of claim 1, wherein the act of collecting and analyzing network bandwidth information of users to obtain bandwidth utilization comprises:
determining the bandwidth utilization according to a predetermined download speed corresponding to collected network bandwidth information of a user and a current download speed of the user.

6. An electronic device, comprising:
at least one processor; and
a memory communicably connected with the at least one processor configured to store instructions executable by the at least one processor, wherein execution of the instructions by the at least one processor causes the at least one processor to:
collect and analyze network bandwidth information of users to obtain bandwidth utilization;
determine a corresponding optimal data rate according to the bandwidth utilization;
compare the optimal data rate to a data rate of a current streaming media transmission, and decide whether to adjust the data rate of the current streaming media transmission based upon the comparison; and
maintain the data rate of the current streaming media transmission or transmit stream media data to users based on the optimal data rate.

7. The electronic device of claim 6, wherein execution of the instructions by the at least one processor further causes the at least one processor to compare the data rate of the current streaming media transmission with the optimal data rate, and decide not to adjust the data rate if the optimal data rate is consistent with the current data rate, or to adjust the data rate if the optimal data rate is inconsistent with the current data rate.

8. The electronic device of claim 6, wherein execution of the instructions by the at least one processor further causes the at least one processor to:
determine a rate-limiting ratio of the streaming media transmission according to the bandwidth utilization; and
determine the optimal data rate according to the rate-limiting ratio and a predetermined ratio/data rate model.

9. The electronic device of claim 8, wherein the predetermined ratio/data rate model is determined based on (i) a ratio between download speed of the user in the historical data and the data rate, and (ii) performance quality of streaming media that is playing.

10. The electronic device of claim 6, wherein execution of the instructions by the at least one processor further causes the at least one processor to:
determine the bandwidth utilization according to a predetermined download speed corresponding to collected network bandwidth information of a user and a current download speed of the user.

11. A non-transitory computer-readable storage medium storing executable instructions that, when executed by one or more processors associated with an electronic device, cause the electronic device to:
collect and analyze network bandwidth information of users to obtain bandwidth utilization;
determine a corresponding optimal data rate according to the bandwidth utilization;
compare the optimal data rate to a data rate of a current streaming media transmission, and decide whether to adjust the data rate of the current streaming media transmission based upon the comparison; and
maintain the data rate of the current streaming media transmission or transmit stream media data to users based on the optimal data rate.

12. The non-transitory computer-readable storage medium of claim 11, wherein execution of the instructions by the electronic device further causes the electronic device to compare the data rate of the current streaming media transmission to the optimal data rate, and decide not to adjust the data rate if the optimal data rate is consistent with the current data rate, or to adjust the data rate if the optimal data rate is inconsistent with the current data rate.

13. The non-transitory computer-readable storage medium of claim 11, wherein execution of the instructions by the electronic device further causes the electronic device to:
determine a rate-limiting ratio of the streaming media transmission according to the bandwidth utilization; and
determine the optimal data rate according to the rate-limiting ratio and a predetermined ratio/data rate model.

14. The non-transitory computer-readable storage medium of claim 12, wherein the predetermined ratio/data rate model is determined based on (i) a ratio between download speed of the user in the historical data and the data rate, and (ii) performance quality of stream media playing.

15. The non-transitory computer-readable storage medium of claim 11, wherein execution of the instructions by the electronic device further causes the electronic device to:
determine the bandwidth utilization according to a predetermined download speed corresponding to collected network bandwidth information of a user and a current download speed of the user.
